(19) United States
(12) Patent Application Publication
(10) Pub. No.: US 2025/0088900 A1
(43) Pub. Date: Mar. 13, 2025

(54) LOW LATENCY, LOW LOSS, SCALABLE THROUGHPUT SUPPORT AND QUEUING

(71) Applicant: Cisco Technology, Inc., San Jose, CA (US)

(72) Inventors: Jerome Henry, Pittsboro, NC (US); Juan Carlos Zuniga, Montreal (CA); Binita Gupta, San Diego, CA (US); Robert E. Barton, Richmond (CA)

(73) Assignee: Cisco Technology, Inc., San Jose, CA (US)

(21) Appl. No.: 18/884,850

(22) Filed: Sep. 13, 2024

Related U.S. Application Data
(60) Provisional application No. 63/582,409, filed on Sep. 13, 2023.
(60) Provisional application No. 63/582,493, filed on Sep. 13, 2023.

(51) Int. Cl. H04W 28/02

(52) U.S. Cl. CPC H04W 28/0289

(57) ABSTRACT

Low Latency, Low Loss, Scalable Throughput (L4S) support and queuing and, specifically, L4S proxy support for non-L4S-compatible devices and L4S queuing for Access Points (APs) may be provided. Providing L4S support can include determining a flow for a L4S capable Station (STA) is L4S enabled. In response to determining the flow is L4S enabled, a shallow queuing mechanism is implemented for queuing traffic by replacing one or more alternate queues with one or more L4S queues, the shallow queuing mechanism comprising one or more classic queues and the one or more L4S queues. L4S traffic of the flow is queued in at least one of the one or more L4S queues.

### RELATED APPLICATION

Under provisions of 35 U.S.C. § 119 (e), Applicant claims the benefit of and priority to U.S. Provisional Application No. 63/582,409 filed Sep. 13, 2023, and U.S. Provisional Application No. 63/582,493 filed Sep. 13, 2023, the disclosures of which are incorporated herein by reference in their entirety.

### TECHNICAL FIELD

The present disclosure relates generally to providing Low Latency, Low Loss, Scalable Throughput (L4S) support and queuing and specifically to providing L4S proxy support for non-L4S-compatible devices and L4S queuing for Access Points (APs).

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for Low Latency, Low Loss, Scalable Throughput (L4S) support and queuing in accordance with aspects of the present disclosure.

FIG. 2 is a block diagram of a L4S queuing system in accordance with aspects of the present disclosure.

FIG. 3 is a block diagram of a shallow queuing mechanism of FIG. 2 in accordance with aspects of the present disclosure.

FIG. 4 is a flow chart of a method for L4S support in accordance with aspects of the present disclosure.

FIG. 5 is a flow chart of a method for L4S queuing in accordance with aspects of the present disclosure.

FIG. 6 is a block diagram of a computing device in accordance with aspects of the present disclosure.

FIG. 7 is a block diagram of a computing device in accordance with aspects of the present disclosure.

### DETAILED DESCRIPTION

### Overview

Low Latency, Low Loss, Scalable Throughput (L4S) support and queuing and, specifically, L4S proxy support for non-L4S-compatible devices and L4S queuing for Access Points (APs) may be provided. Providing L4S support can include determining a flow for a L4S capable Station (STA) is L4S enabled. In response to determining the flow is L4S enabled, a shallow queuing mechanism is implemented for queuing traffic by replacing one or more alternate queues with one or more L4S queues, the shallow queuing mechanism comprising one or more classic queues and the one or more L4S queues. L4S traffic of the flow is queued in at least one of the one or more L4S queues.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Low Latency, Low Loss, Scalable Throughout (L4S) is an architecture and protocol described in the Internet Engineering Task Force (IETF) standards (e.g., the IETF Request for Comment (RFC) 9330, 9331, 9332). L4S is implemented to provide low queuing latency, low congestion loss, and scalable throughput control for streaming video, multiplayer games, and other real-time applications. By handling data packet processing and reducing network congestion, L4S minimizes delays caused by queue bloat and enables smoother and more efficient data transmission.

Integrating L4S with existing network infrastructures and ensuring compatibility with a wide range of applications can be challenging. For example, L4S may require multiple features compatible with its requirements for integration or assume the existence of the features for operation. These features and/or other L4S requirements may not be supported by existing legacy devices manufactured before the implementation of L4S. The features can include the existence of a scalable congestion control at a sender host capable of keeping an average time for congestion signals as the flow rate scales, a packet identifier at the Internet Protocol (IP) layer to be used as an explicit congestion control signaling protocol, support for detailed Explicit Congestion Notification (ECN) feedback, the capability to isolate traffic in separate queues so L4S traffic can be kept on a shallow queue, and a conditional priority scheduler that can give preference to L4S traffic over other types of traffic. L4S can have different requirements based on the infrastructure of the network L4S is being implemented in.

Although L4S is being adopted for multiple devices, many legacy devices without L4S capabilities may remain deployed in network environments. If an endpoint (i.e., any device connected to a network that serves as an endpoint for data communications) is not L4S enabled, the endpoint may not benefit from L4S being implemented onto the network nodes. Devices that cannot leverage L4S features can also limit the benefits L4S capable devices realize. Current L4S standards even detail requiring both end nodes to signal ECN support as a prerequisite for L4S congestion control. L4S can be beneficial, especially for real-time services, as implemented in several network environments, but the positive effects of L4S may only be attained if L4S is supported for the most critical elements of the network path. Legacy devices present in the network can therefore comprise the effectiveness of L4S.

Wireless links are usually one of the main bottlenecks in a network path due to its shared medium nature. Further, most of the Internet traffic uses at least one wireless link in its path. Because there may be numerous legacy devices (e.g., millions of devices) deployed that will not be L4S compatible and/or upgradable, the implementation of L4S may not be able to be leveraged to improve network performance. Supporting L4S in the presence of non-compatible nodes is described herein to enable L4S for legacy devices. Thus, all devices of a network can benefit from the L4S features when proxy L4S support is provided.

Additionally, wireless shared media access is typically stochastic and hard to predict. This is especially true in dense wireless environments with multiple clients trying to access the medium simultaneously. When L4S is used upstream, an Access Point (AP) may need to schedule an L4S capable Station (STA) in a way that minimizes the build-up of the STA buffer. The upstream traffic then needs to traverse the AP through a shallow queuing mechanism or another L4S queue. When an AP receives L4S traffic downstream, the AP needs to know if the destination is an L4S capable STA. If the STA is L4S capable, the AP may bypass the regular queuing structure (e.g., as defined in the Institute of Electrical and Electronics Engineers (IEEE) 802.11 standards and amendments) and use a shallow queuing mechanism (e.g., as described in the IETF RFC 9330). If a STA is not L4S capable, then the STA will be unable to handle L4S marking (e.g., ECN, Congestion Experienced (CE)). Using a shallow queue accelerates AP traversal, but when a device cannot react to L4S marking, the AP may need to reduce transmission speed. Thus, the AP may ignore the L4S signaling of the packet and use a regular queue instead of a shallow queue. Methods for enabling APs to utilize shallow queues for L4S capable STAs after devices have signaled their support for L4S is described herein.

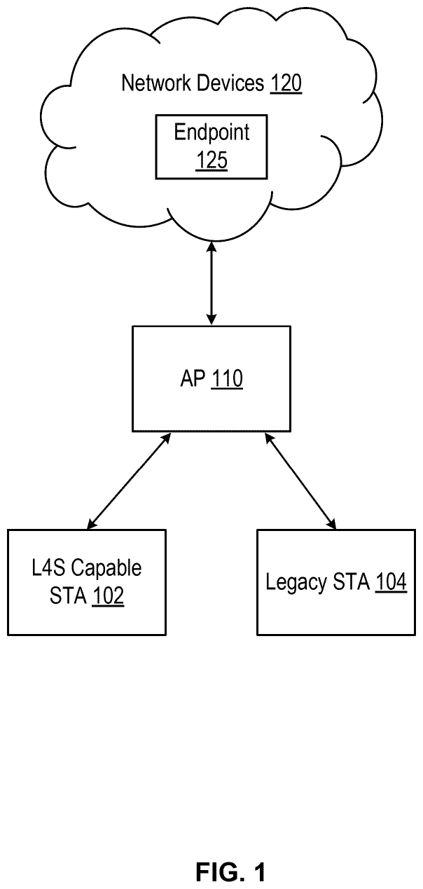

FIG. 1 is a block diagram of an operating environment 100 for L4S support and queuing in accordance with aspects of the present disclosure. The operating environment 100 includes a LAS capable STA 102, a legacy STA 104, an AP 110, and network devices 120. The L4S capable STA 102 and the legacy STA 104 can be any device (e.g., a smart phone, a tablet, a personal computer, a server, etc.) that connects to the network, such as to communicate with other devices on the network (e.g., network devices 120). The L4S capable STA 102 may be able to utilize L4S, and the legacy STA 104 may not be able to utilize L4S on its own. The AP 110 may enable devices within range of the AP 110, including the L4S capable STA 102 and the legacy STA 104, to connect to devices and applications of the network, including the network devices 120. The AP 110 may be L4S capable and able to provide proxy L4S support. The network devices 120 can be devices that can be communicated with via the network (e.g., via the Internet) and/or other network devices. The network devices 120 can include L4S capable devices and legacy devices not capable of utilizing L4S alone. The network devices 120 includes an endpoint 125, and the endpoint 125 may be a L4S capable device communicating with the legacy STA 104.

### Proxy L4S Support

To utilize L4S, devices may perform marking and/or otherwise notify devices of L4S support, such as the L4S capable STA 102 marking packets it sends to a network device 120. For example, endpoints can mark packets they send to other devices using an ECN field. The ECN field can include one or more bits in a packet header that can be set to indicate L4S support, indicate congestion, etc. For example, an ECN field with bits set to 00 indicates that the traffic is not ECN-capable, 01 indicates that the traffic is L4S capable, 10 indicates that the traffic is ECN-capable, and 11 indicates CE, when congestion is experienced. Thus, a device can use marking (e.g., using the ECN field) to indicate that the device is LAS capable to other devices.

Devices, such as the AP 110, may similarly use marking to indicate proxy L4S support for devices that cannot support L4S alone, such as the legacy STA 104. In certain embodiments, when a proxy device detects association of a device that cannot support L4S alone and detect support for L4S from the other end of a communication flow associated with the device that cannot support L4S alone, the proxy device can indicate that it will perform L4S functionalities on behalf of the device that cannot support L4S alone. For example, the AP 110 can detect or otherwise determine the legacy STA 104 cannot support L4S alone. The AP 110 can additionally detect that a network device 120, such as the endpoint 125, communicating on a certain flow with the legacy STA 104 supports L4S (e.g., an L4S capable device sending downstream reply flow reaching the AP 110 and intended for the legacy STA 104). In response, the AP 110 can send an indication that to the endpoint 125 that the AP 110 will provide proxy L4S support and/or otherwise indicate the communication flow between the endpoint 125 and the legacy STA 104 can utilize L4S.

When the AP 110 is providing proxy L4S support for the legacy STA 104, the AP 110 can use marking to indicate the L4S support to the endpoint 125. For example, the AP 110 can mark subsequent communications from the legacy STA 104 to the endpoint 125 (e.g., the legacy STA's 104 upstream traffic) to indicate the L4S support. The marking can comprise setting bits in an ECN field in certain embodiments. For example, the AP 110 sets one or more ECN field bits in the packet headers of the packets the legacy STA 104 is sending to indicate L4S support (e.g., setting the ECN bits to 01 to indicate that the traffic is L4S capable). In some embodiments, the AP 110 can apply the marking on flow setup messaging (e.g. during the three-way handshake via Transmission Control Protocol (TCP) Synchronize Sequence Numbers (SYN) packets, TCP Acknowledge (ACK) packets, TCP SYN-ACK packets, etc.), thereby enabling L4S support when initiating the communication connection.

When a device acting as a L4S proxy device detects congestion from a downstream device, the L4S proxy device can cause the source of the traffic where congestion is being experienced (e.g., the device being provided L4S proxy support) to reduce its Transmit (TX) rate. For example, the legacy device 104 may be transmitting to the endpoint 125, and the endpoint 125 experiences congestion. The endpoint 125 may send a packet with a congestion indication (i.e., ECN field bits set to 11). When the AP 110 receives packets from the endpoint 125 with the congestion indication, the AP 110 can cause the legacy STA 104 to reduce its TX rate in an attempt to alleviate the congestion.

In some embodiment, the AP 110 causes the legacy STA 104 to reduce its TX rate indirectly, for example by limiting the number of medium access opportunities given to the legacy STA 104, thereby forcing the STA to slow its TX rate or drop packets at the source. In other embodiments, the AP 110 can cause the legacy STA 104 to reduce its TX rate by lowering the number and/or frequency of trigger frames sent to the legacy STA 104 for uplink transmissions. In yet other embodiments, the AP 110 sends an indication or other message to the legacy STA 104 instructing the legacy STA 104 to lower its TX rate, such as to change its traffic profile to a downgraded one and therefore lower its TX rate. The AP 110 may utilize a TCP flag, a User Datagram Protocol (UDP) flag, a separate control channel, and/or the like to instruct the legacy STA 104 to reduce its TX rate in other example implementations.

When the legacy STA 104 and the endpoint 125 are exchanging TCP L4S traffic, the AP 110 can rate-limit the legacy STA 104 directly at the AP 110 (or controller), thereby forcing the TCP TX rate to slow down. Alternatively, the AP 110 can initiate Weighted Random Early Detection (WRED) to randomly drop packets in the flow, which would result in a similar outcome of lowering the congestion for the endpoint 125. For L4S, an Adaptive Queue Management (AQM) system can control dropping packets for traffic in both the L4S queue and the classic queues. TCP packet drops would force both endpoints to slow down even without L4S markings indicating to slow transmission speed. In these embodiments, the rate-limiting speed is correlated with the level and rate of change of congestion detected in the L4S queue. When the legacy STA 104 and the endpoint 125 are exchanging UDP traffic, the AP 110 can reduce its Modulation and Coding Scheme (MCS) to change the link speed of the legacy STA 104, forcing the legacy STA 104 to a lower bitrate.

The L4S proxy device can also send congestion notifications upstream to the other endpoint device so the endpoint device can reduce its TX rate. For example, the AP 110 can detect congestion (e.g., over-the-air, in the AP queue, etc.) when the legacy STA 104 is receiving traffic from the endpoint 125 and send a congestion notification (e.g., ECN bits set to 11) to the endpoint 125. In certain embodiments, the AP 110 marks the packets the legacy STA 104 sends to the endpoint 125 for indicating the congestion. The endpoint 125 can reduce its TX rate in response receiving the congestion notification.

In other embodiments, a middle-node of the network path can provide proxy L4S support functionality, such as another network device 120 that is between the path of the legacy STA 104 and the endpoint 125. For example, an AP enabling the endpoint 125 to connect to the network may act as the L4S proxy device. Other devices may provide proxy L4S support, such as controllers, servers, relays, AQMs, and/or the like.

### L4S Queuing

The AP 110 can activate and utilize a shallow queuing mechanism when devices are L4S capable. The AP 110 can determine whether devices support L4S via signaling from the devices, such as marking. In some embodiments, a device can indicate that all flows are L4S. In other embodiments, a device can indicate that particular flows are L4S and other flows are not L4S supported.

The IEEE 802.11 standard allows for four Access Categories (ACs), with two User Priority (UP) values each (e.g. 802.11-2020 9.4.2.30). The AP 110 can use the four ACs and two UP values of each AC to distribute flows between L4S queues and classic queues. For example, the AP 110 can use an UP value of one AC for a first L4S queue and an UP value of a second AC for a second L4S queue. The AP 110 can therefore assign packets to L4S queues or classic queues using the UP values. In an example implementation, there is a classic queue for the background AC, a L4S queue and a classic queue for a best effort AC, a L4S queue and a classic queue for a video AC, and a classic queue for a voice AC. In other embodiments, another number of ACs and/or associated UP values may be utilized.

For downstream flow (e.g., network devices 120 transmitting to STAs associated to the AP 110 such as the L4S capable STA 102 and the legacy STA 104), the AP 110 can determine the UP and the AC mapping for a flow based on internal policies and/or the Differentiated Services Code Point (DSCP) value of the packet incoming from the Distribution System (DS). Some provisions of the IEEE 802.11 standard (e.g., 802.11aa 10.4) allow STAs to indicate to an associated AP that some flows have a particular Discard Eligibility (DE), such as with a DE Indicator (DEI), to indicate that frames can be discarded when a network is congested. For flows with DE, the AP can use an alternate queue (e.g., an intra-AC queue). For example, the AP 110 can use the alternate queue for the video AC for flows with DE.

The shallow queuing mechanism includes replacing existing alternate queues with shallow queues as described above. Thus, when the downstream flow for an L4S-capable STA is L4S-enabled, the AP 110 can replace one or more alternate queues for the given flow with an L4S queue. In example implementations, no intra-AC traffic can be in an alternate queue when replacing the alternate queue with an L4S queue.

In certain embodiments, an AC can include a regular queue where non-L4S traffic is queued and a typical Enhanced Distributed Channel Access (EDCA) countdown occurs. The AC can also include an L4S queue, such as a shallow queue. When a predetermined or otherwise set number of frames are in the L4S queue, the AP 110 starts detecting congestion for the L4S flows and starts marking downstream traffic with an ECN CE value (e.g., ECN bits set to 11). The marking allows the receiving STA (e.g., the L4S capable STA 102) to be made aware of the congestion, causing the STA to reflect the congestion warning to the source of the traffic and causing the source to slow down its flow to the STA. In certain embodiments, the AP 110 can provide proxy L4S support and cause one or more devices to reduce the TX rate using one or more of the methods described above. When the maximum number of frames are in the L4S queue, the AP 110 declares that the L4S queue is congested, and the AP 110 drops any new frames incoming into the queue. As the number of frames in the L4S queue reduces, the AP 110 will continue to mark the frames with the CE marking (e.g., ECN field set to 11) until the L4S queue has less than the predetermined number of frames.

In embodiments, the L4S queue is shallow and with low delay, so the L4S queue can benefit from specific transmitting conditions. In some embodiments, the frames in the L4S queue are transmitted using typical EDCA rules (e.g., according to EDCA rules for Arbitration Inter-Frame Spacing Number (AIFSN), Minimum Contention Window (CWmin), Maximum Contention Window (CWmax), retries, etc.). In other embodiments, the L4S queue is always sent with a low delay. AIFSN applies in the low delay mode, but the STA may randomly select a countdown timer with a value less than CWmin, including for retries, thereby maximizing the chances that the frame will be sent with low delay. In example implementations, the value of CWmin is the value allocated for the highest priority queue. The STA may therefore select the shortest random timer possible (e.g., as allowed by the IEEE 802.11 standard) irrespective of the queue within which the flow operates.

If the AP 110 fails to receive an acknowledgement for more than a predetermined or otherwise known number of retries for a given L4S frame, the AP 110 may determine the medium is congested. In one embodiment, the AP 110 declares internal congestion and prioritizes the L4S frames above all other frames. For example, the prioritization of L4S frames may be a form of Priority Queuing (PQ) for L4S, where non-L4S queues are not transmitted until the L4S queues in all ACs are empty. In some embodiments, the AP 110 can signal (e.g., using marking such as setting bits in the ECN field) that congestion is experienced for the L4S flows that are forwarded after more than a predetermined or otherwise known amount of retries, causing the L4S flow to eventually slow down to match the medium capacity.

In certain embodiments, one or more STAs associated to an AP may utilize alternate queues for other purposes than L4S, such as according to typical intra-AC queuing techniques. For example, the legacy STA 104 or one or more network devices 120 can use an alternate queue for DE packets. If a STA is utilizing an alternate queue for purposes other than L4S and the AP 110 receives an L4S frame, such as from the L4S capable STA 102, the AP 110 can discard any packets associated with the other purposes (e.g., DE packets) in the alternate queue and use the alternate queue as a shallow L4S queue. In other embodiments, the AP 110 puts a hold on the alternate queue, redirecting packets in the alternate queue to the standard queue of the AC, storing the packets until the shallow L4S queue becomes empty, and/or the like.

In some embodiments, one or more STAs associated to an AP may utilize alternate queues for both L4S purposes and non-L4S purposes, such as according to typical intra-AC queuing techniques. For example, the L4S capable STA 102 may use the alternate queues for L4S purposes and for DE packets. The AP 110 can determine flags of the packets indicating for L4S purposes and/or for non-L4S purposes as contradictory and only consider one flag or otherwise give priority to one flag in example implementations. For example, the AP 110 can determine the flow is L4S and thus affected to a shallow queue, or the AP 110 can determine the flow is DE within the alternate AC queue. In other embodiments, the AP 110 can combine the flag requirements. The AP 110 may make the alternate queue a L4S queue as described above and only direct L4S (both intra-AC and non-intra-AC) frames to the L4S queue. When an intra-AC frame enters the L4S queue and the queue already has more than a predetermined or otherwise known amount of L4S frames, the AP 110 discards the intra-AC frame from the L4S queue. The AP 110 can also discard intra-AC frames that are already queued if the L4S queue already has more than the predetermined or otherwise known amount of L4S frames. Thus, the AP 110 may discard intra-AC frames to manage congestion.

The AP 110 and/or other devices may insert or otherwise include an L4S flag in the header of L4S transmissions so devices can distinguish L4S transmissions and non-L4S transmissions. The flags can be used for example for organizing the queues, for determining which devices support L4S, and/or the like.

For the upstream direction of traffic (e.g., from STAs associated to the AP 110 to network devices), the AP 110 may receive a frame from a single radio, irrespective of the AC from which the STA transmitted the frame. When the AP 110 receives an upstream frame, the AP 110 forwards it back to the Basic Service Set (BSS), to another radio, or to the DS (e.g., to the network devices 120). When the destination is the BSS or another radio, the above methods for utilizing L4S queues apply. When the destination is the DS, the AP 110 can implement on its DS interface at least a two-queue system including at least one standard queue and one L4S queue.

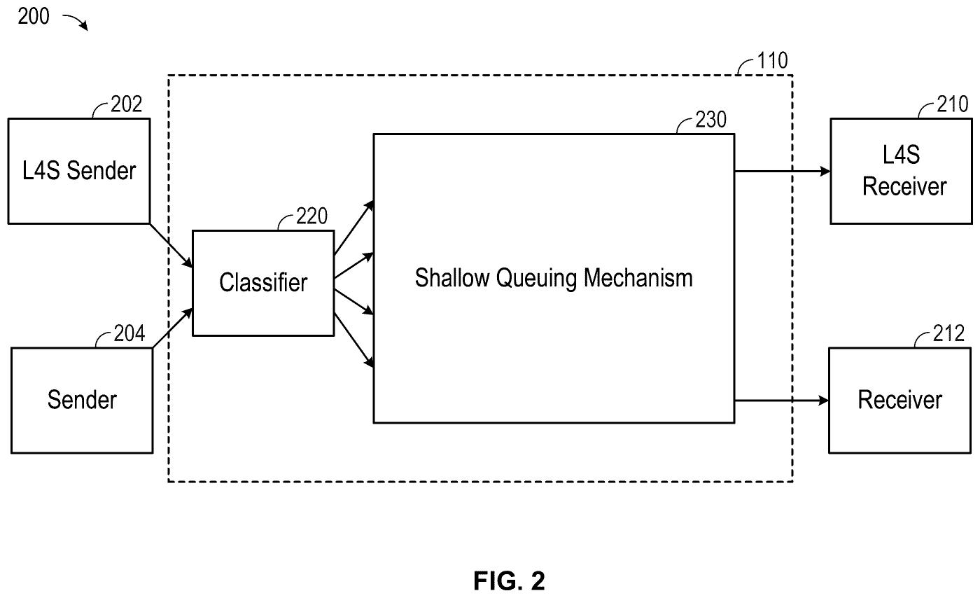

In embodiments, the AP 110 and/or other devices can use utilize the shallow queuing mechanism for a non-L4S capable device, such as the legacy STA 104, when there is a proxy L4S device providing L4S support to the non-L4S capable device. The shallowing queuing mechanism is described in further detail herein with respect to FIG. 2.

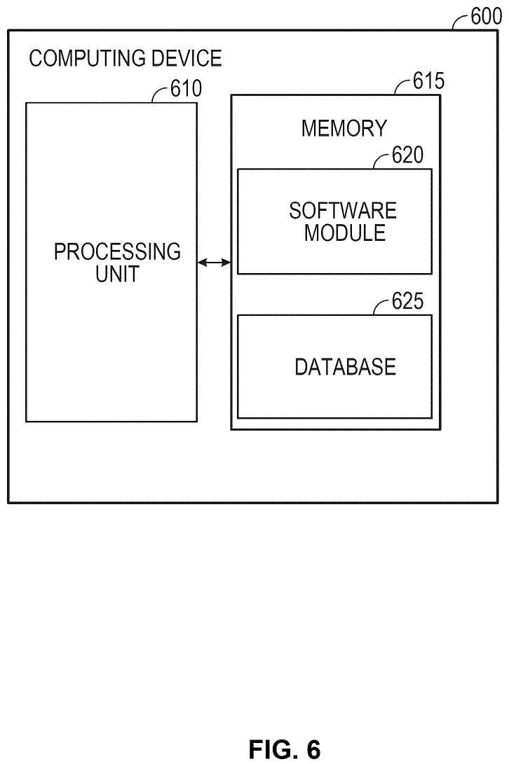

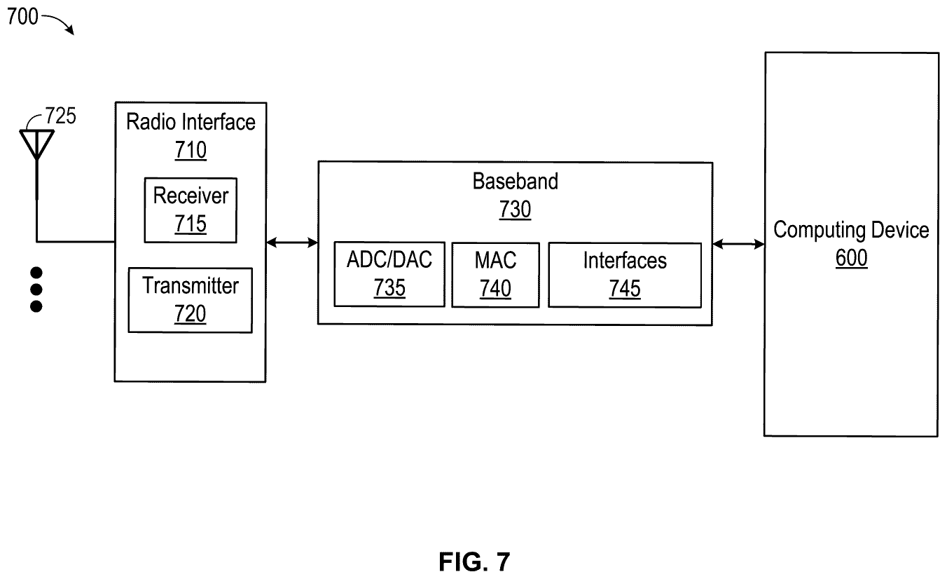

The elements described above of the operating environment 100 (e.g., the L4S capable STA 102, the legacy STA 104, the AP 110, the network devices 120, the endpoint 125, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 6 and 7, the elements of the operating environment 100 may be practiced in a computing device 600 and/or communications device 700.

FIG. 2 is a block diagram of a L4S queuing system 200 in accordance with aspects of the present disclosure. The AP 110 and/or other devices can implement the L4S queuing system 200 to perform L4S queuing as described above. The L4S queuing system 200 can include a L4S sender 202, a sender 204, a L4S receiver 210, a receiver 212, and a classifier 220 and a shallow queuing mechanism 230 in the AP 110.

The L4S sender 202 can be a traffic source, such as the L4S capable STA 102 or a device of the network devices 120, sending L4S traffic. The sender 204 can be a traffic source, such as the legacy STA 104 or a device of the network devices 120, sending non-L4S traffic. The L4S receiver 204 can be a L4S capable device, such as the L4S capable STA 102 or a device of the network devices. The receiver 212 can be a non-L4S capable device, such as the legacy STA 104 or a device of the network devices 120. The AP 110 and/or another device can provide proxy L4S support for the sender 204 and/or the receiver 212 in certain embodiments.

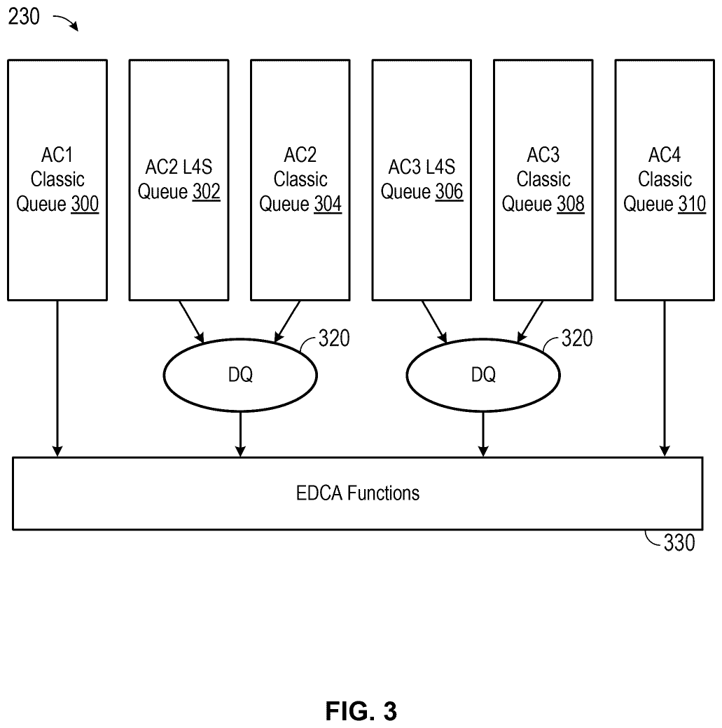

The classifier 220 may classify the types of traffic and sort L4S traffic and non-L4S traffic into different queues of the shallow queuing mechanism 230. FIG. 3 is a block diagram of the shallow queuing mechanism 230 shown in FIG. 2. The shallow queuing mechanism 230 includes a first AC classic queue 300, a second AC L4S queue 302, a second AC classic queue 304, a third AC L4S queue 306, a third AC classic queue 308, and a fourth AC classic queue 310. In some embodiments, the first AC is a background AC, the second AC is a best effort AC, the third AC is a video AC, and the fourth AC is a voice AC. The best effort AC and the video AC may include both a classic queue and a L4S queue because the best effort AC and the video AC can manage a mix of L4S flows and classic flows. However, different ACs can have both a classic queue and L4S queue in other embodiments.

The shallow queuing mechanism 230 also may include Distributed Queuing (DQ) switches 320. The second AC L4S queue 302 and the second AC classic queue 304 can both send the queued traffic from the queues to a DQ switch 320, and the third AC L4S queue 306 and the third AC classic queue 308 can send the queued traffic from the queues to a DQ switch 320. The shallow queuing mechanism 230 also includes EDCA functions 330 for the first AC classic queue 300, DQ switches 320, and the fourth AC classic queue 310 to send queued traffic for subsequent transmission toward the respective endpoint. The shallow queuing mechanism 230 can be implemented at the Media Access Control (MAC) layer to enable control for L4S flow scheduling with low queuing delay and high output.

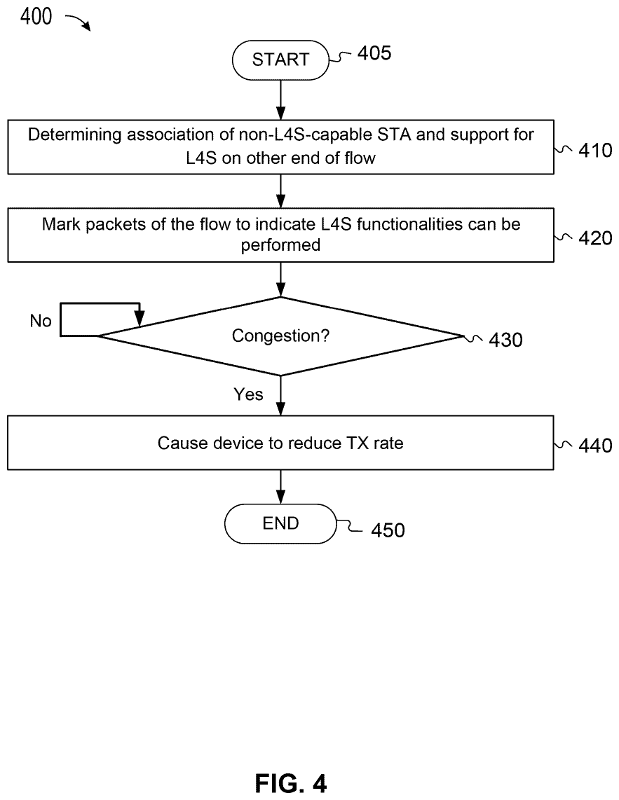

FIG. 4 is a flow chart of a method 400 for L4S support in accordance with aspects of the present disclosure. The method 400 can begin at starting block 405 and proceed to operation 410. In operation 410, an association of a non-L4S-capable STA and support for L4S on an other end of a flow is determined. For example, the AP 110 determines the legacy STA 104 is not L4S capable, identifies the flow between the legacy STA 104 and the endpoint 125, and determines the endpoint 125 supports L4S. Thus, the AP 110 may provide the legacy STA 104 L4S support to enable L4S for the flow between the legacy STA 104 and the endpoint 125.

In operation 420, packets of the flow of are marked to indicate L4S functionalities can be performed. For example, the AP 110 can mark the packets of the flow as described above with respect to FIG. 1 to indicate L4S is supported. In decision 430, it is determined whether there is congestion. For example, the AP 110 determines whether there is congestion associated with the flow. The AP 110 can continuously monitor the flow to determine when congestion occurs. When the AP 110 determines there is congestion, either upstream or downstream, the method 400 can proceed to operation 440. In operation 440, the AP 110 can cause a device to reduce its TX rate. For example, the AP 110 can cause the legacy STA 104 and/or the endpoint 125 to reduce its TX rate depending on whether the congestion is in the upstream and/or the downstream direction of the flow. The AP 110 can cause the devices to reduce the TX rate according to the methods described above with respect to FIG. 1. The method 400 can conclude at ending block 450.

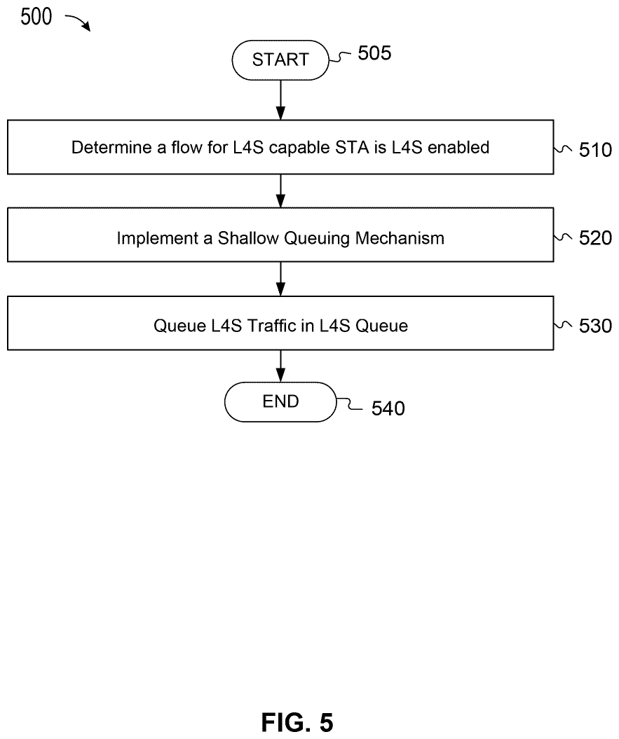

FIG. 5 is a flow chart of a method 500 for L4S queuing in accordance with aspects of the present disclosure. The method 500 can begin at starting block 505 and proceed to operation 510. In operation 510, it is determined that a flow for a L4S capable STA is L4S enabled. For example, the AP 110 determines a flow between the L4S capable STA 102, and the endpoint is L4S enabled. In some embodiments, an endpoint of the flow, such as the legacy STA 104, may not support L4S. However, the AP 110 and/or another device may provide proxy L4S support to make the endpoint of the flow L4S capable.

In operation 520, in response to determining the flow is L4S enabled, a shallow queuing mechanism is implemented. For example, the AP 110 implements the shallow queuing mechanism 230 for queuing traffic by replacing one or more alternate queues with one or more L4S queues (e.g., the second AC L4S queue 302 and the third AC L4S queue 306). The shallow queuing mechanism 230 can comprise one or more classic queues and the one or more L4S queues. For example, the shallow queuing mechanism 230 can include the first AC classic queue 300, the second AC L4S queue 302, the second AC classic queue 304, the third AC L4S queue 306, the third AC classic queue 308, and the fourth AC classic queue 310. The L4S queues may be shallow queues in embodiments.

In operation 530, L4S traffic of the flow is queued in at least one of the one or more L4S queues. For example, the AP 110 queues L4S traffic of the flow in the second AC L4S queue 302 and/or the third AC L4S queue 306. In some embodiments, the AP 110 can detect congestion of the flow. The AP 110 can then mark L4S traffic of the flow with a CE value (e.g., ECN bits set to 11). In certain embodiments, the AP 110 determines an STA is utilizing an alternate queue for non-L4S reasons (e.g., DE packets). The AP 110 can discard the packets of the STA, redirect the packets of the STA to another queue, temporarily store the packets of the STA while the queue is used as an L4S queue, and/or the like.

In some embodiments, the AP determines a STA is utilizing an alternate queue for both an LAS flow and a non-L4S flow. The AP 110 can direct traffic from the L4S flow and the non-L4S flow to an L4S queue replacing the alternate queue. If the AP 110 determines the L4S queue has an amount of traffic queued over a threshold, the AP 110 can remove traffic of the non-L4S flow from the L4S queue until the amount of traffic queued is below the threshold.

When the AP 110 is providing proxy L4S support, the AP 110 can mark L4S traffic of the flow to indicate L4S is supported. The AP 110 can also determine the flow has congestion and cause the L4S capable STA (e.g., the legacy STA 104 as a L4S capable STA because of proxy L4S support), the endpoint 125, and/or the like to reduce its TX rate, such as via the methods described above with respect to FIG. 1. The method 500 can conclude at ending block 540.

FIG. 6 is a block diagram of a computing device 600. As shown in FIG. 6, computing device 600 may include a processing unit 610 and a memory unit 615. Memory unit 615 may include a software module 620 and a database 625. While executing on processing unit 610, software module 620 may perform, for example, processes for L4S support and queuing with respect to FIG. 1, FIG. 2, FIG. 3, FIG. 4, and FIG. 5. Computing device 600, for example, may provide an operating environment for L4S capable STA 102, the legacy STA 104, the AP 110, the network devices 120, the endpoint 125, and the like. The L4S capable STA 102, the legacy STA 104, the AP 110, the network devices 120, the endpoint 125, and the like may operate in other environments and are not limited to computing device 600.

Computing device 600 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 600 may comprise any computer operating environment, such as hand-held devices, multiprocessor systems, microprocessor-based or programmable sender electronic devices, minicomputers, mainframe computers, and the like. Computing device 600 may also be practiced in distributed computing environments where tasks are performed by remote processing devices. The aforementioned systems and devices are examples, and computing device 600 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general-purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 600 on the single integrated circuit (chip).

FIG. 7 illustrates an implementation of a communications device 700 that may implement one or more of the L4S capable STA 102, the legacy STA 104, the AP 110, the network devices 120, the endpoint 125, etc., of FIGS. 1-5. In various implementations, the communications device 700 may comprise a logic circuit. The logic circuit may include physical circuits to perform operations described for one or more of the L4S capable STA 102, the legacy STA 104, the AP 110, the network devices 120, the endpoint 125, etc., of FIGS. 1-5, for example. As shown in FIG. 7, the communications device 700 may include one or more of, but is not limited to, a radio interface 710, baseband circuitry 730, and/or the computing device 600.

The communications device 700 may implement some or all of the structures and/or operations for the L4S capable STA 102, the legacy STA 104, the AP 110, the network devices 120, the endpoint 125, etc., of FIGS. 1-5, storage medium, and logic circuit in a single computing entity, such as entirely within a single device. Alternatively, the communications device 700 may distribute portions of the structure and/or operations using a distributed system architecture, such as a client station server architecture, a peer-to-peer architecture, a master-slave architecture, etc.

A radio interface 710, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 710 may include, for example, a receiver 715 and/or a transmitter 720. The radio interface 710 may include bias controls, a crystal oscillator, and/or one or more antennas 725. In additional or alternative configurations, the radio interface 710 may use oscillators and/or one or more filters, as desired.

The baseband circuitry 730 may communicate with the radio interface 710 to process, receive, and/or transmit signals and may include, for example, an Analog-To-Digital Converter (ADC) for down converting received signals with a Digital-To-Analog Converter (DAC) 735 for up converting signals for transmission. Further, the baseband circuitry 730 may include a baseband or Physical Layer (PHY) processing circuit for the PHY link layer processing of respective receive/transmit signals. Baseband circuitry 730 may include, for example, a MAC processing circuit 740 for MAC/data link layer processing. Baseband circuitry 730 may include a memory controller for communicating with MAC processing circuit 740 and/or a computing device 600, for example, via one or more interfaces 745.

In some configurations, PHY processing circuit may include a frame construction and/or detection module, in combination with additional circuitry such as a buffer memory, to construct and/or deconstruct communication frames. Alternatively or in addition, MAC processing circuit 740 may share processing for certain of these functions or perform these processes independent of PHY processing circuit. In some configurations, MAC and PHY processing may be integrated into a single circuit.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
determining a flow for a Low Latency, Low Loss, Scalable Throughput (L4S) capable Station (STA) is L4S enabled;
in response to determining the flow is L4S enabled, implementing a shallow queuing mechanism for queuing traffic by replacing one or more alternate queues with one or more L4S queues, the shallow queuing mechanism comprising one or more classic queues and the one or more L4S queues; and
queuing L4S traffic of the flow in at least one of the one or more L4S queues.

2. The method of claim 1, further comprising:
detecting congestion for the flow; and
marking the L4S traffic of the flow with a Congestion Experienced (CE) value.

3. The method of claim 1, further comprising:
determining a STA is utilizing an alternate queue of the one or more alternate queues; and
performing any one of (i) discarding, (ii) redirecting, or (iii) temporarily storing, traffic associated with the STA in the alternate queue before replacing the alternate queue with an L4S queue of the one or more L4S queues.

4. The method of claim 1, further comprising:
determining a STA is utilizing an alternate queue of the one or more alternate queues for both an L4S flow and a non-L4S flow;
directing traffic from the L4S flow and the non-L4S flow to an L4S queue of the one or more L4S queues replacing the alternate queue;
determining the L4S queue has an amount of traffic queued over a threshold; and
removing traffic of the non-L4S flow from the L4S queue until the amount of traffic queued is below the threshold.

5. The method of claim 1, wherein the shallow queuing mechanism comprises a first Access Category (AC) classic queue, a second AC L4S queue, a second AC classic queue, a third AC L4S queue, a third AC classic queue, and a fourth AC classic queue.

6. The method of claim 1, further comprising:
determining the L4S capable STA does not support L4S; and
providing proxy L4S support to enable the L4S capable STA to support L4S, wherein providing proxy L4S support comprises marking L4S traffic of the flow to indicate L4S is supported.

7. The method of claim 1, further comprising:
providing proxy L4S support to enable the L4S capable STA to support L4S, wherein providing proxy L4S support comprises:
determining the flow has congestion; and
causing any one of (i) the L4S capable STA, (ii) an endpoint of the flow, or (iii) both (i) and (ii), to reduce a Transmit (TX) rate.

8. A system comprising:
a memory storage; and
a processing unit coupled to the memory storage, wherein the processing unit is operative to:
determine a flow for a Low Latency, Low Loss, Scalable Throughput (L4S) capable Station (STA) is L4S enabled;
implement a shallow queuing mechanism for queuing traffic by replacing one or more alternate queues with one or more L4S queues, the shallow queuing mechanism comprising one or more classic queues and the one or more L4S queues; and
queue L4S traffic of the flow in at least one of the one or more L4S queues.

9. The system of claim 8, the processing unit being further operative to:
detect congestion for the flow; and
mark the L4S traffic of the flow with a Congestion Experienced (CE) value.

10. The system of claim 8, the processing unit being further operative to:
determine a STA is utilizing an alternate queue of the one or more alternate queues; and
perform any one of (i) discard, (ii) redirect, or (iii) temporarily store, traffic associated with the STA in the alternate queue before replacing the alternate queue with an L4S queue of the one or more L4S queues.

11. The system of claim 8, the processing unit being further operative to:
determine a STA is utilizing an alternate queue of the one or more alternate queues for both an L4S flow and a non-L4S flow;
direct traffic from the L4S flow and the non-L4S flow to an L4S queue of the one or more L4S queues replacing the alternate queue;
determine the L4S queue has an amount of traffic queued over a threshold; and
remove traffic of the non-L4S flow from the L4S queue until the amount of traffic queued is below the threshold.

12. The system of claim 8, wherein the shallow queuing mechanism comprises a first Access Category (AC) classic queue, a second AC L4S queue, a second AC classic queue, a third AC L4S queue, a third AC classic queue, and a fourth AC classic queue.

13. The system of claim 8, the processing unit being further operative to:
determining the L4S capable STA does not support L4S; and
providing proxy L4S support to enable the L4S capable STA to support L4S, wherein providing proxy L4S support comprises marking L4S traffic of the flow to indicate L4S is supported.

14. The system of claim 8, the processing unit being further operative to:
provide proxy L4S support to enable the L4S capable STA to support L4S, wherein to provide proxy L4S support comprises to:
determine the flow has congestion; and
cause any one of (i) the L4S capable STA, (ii) an endpoint of the flow, or (iii) both (i) and (ii), to reduce a Transmit (TX) rate.

15. A non-transitory computer-readable medium that stores a set of instructions which when executed perform a method executed by the set of instructions comprising:
determining a flow for a Low Latency, Low Loss, Scalable Throughput (L4S) capable Station (STA) is L4S enabled;
in response to determining the flow is L4S enabled, implementing a shallow queuing mechanism for queuing traffic by replacing one or more alternate queues with one or more L4S queues, the shallow queuing mechanism comprising one or more classic queues and the one or more L4S queues; and
queuing L4S traffic of the flow in at least one of the one or more L4S queues.

16. The non-transitory computer-readable medium of claim 15, the method executed by the set of instructions further comprising:
detecting congestion for the flow; and
marking the L4S traffic of the flow with a Congestion Experienced (CE) value.

17. The non-transitory computer-readable medium of claim 15, the method executed by the set of instructions further comprising:
determining a STA is utilizing an alternate queue of the one or more alternate queues; and
performing any one of (i) discarding, (ii) redirecting, or (iii) temporarily storing, traffic associated with the STA in the alternate queue before replacing the alternate queue with an L4S queue of the one or more L4S queues.

18. The non-transitory computer-readable medium of claim 15, wherein the shallow queuing mechanism comprises a first Access Category (AC) classic queue, a second AC L4S queue, a second AC classic queue, a third AC L4S queue, a third AC classic queue, and a fourth AC classic queue.

19. The non-transitory computer-readable medium of claim 15, the method executed by the set of instructions further comprising:
determining the L4S capable STA does not support L4S; and
providing proxy L4S support to enable the L4S capable STA to support L4S, wherein providing proxy L4S support comprises marking L4S traffic of the flow to indicate L4S is supported.

20. The non-transitory computer-readable medium of claim 15, the method executed by the set of instructions further comprising:
providing proxy L4S support to enable the L4S capable STA to support L4S, wherein providing proxy L4S support comprises:
determining the flow has congestion; and
causing any one of (i) the L4S capable STA, (ii) an endpoint of the flow, or (iii) both (i) and (ii), to reduce a Transmit (TX) rate.
